(19) United States
(12) Patent Application Publication
(10) Pub. No.: US 2007/0126155 A1
(43) Pub. Date: Jun. 7, 2007

(54) Mold and method for manufacturing a simulated stone product

(76) Inventors: Michelle L. Korwin-Edson, Pataskala, OH (US); Jonathan M. Verhoff, Reynoldsburg, OH (US)

Correspondence Address: OWENS CORNING, 2790 COLUMBUS ROAD, GRANVILLE, OH, 43023, US

(21) Appl. No.: 11/295,118

(22) Filed: Dec. 6, 2005

(51) Int. Cl. B28B 3/00; B28B 7/12; B28B 13/06; B28B 7/10

(52) U.S. Cl. 264/333; 264/334; 264/335; 425/440; 425/422

(57) ABSTRACT

A mold for manufacturing a simulated stone product includes a flexible layer that defines a mold cavity section in the shape of the simulated stone product to be formed. The flexible layer also has a support section surrounding the mold cavity section. The support section is configured to substantially resist flexing during unmolding of the simulated stone product.

### TECHNICAL FIELD AND INDUSTRIAL APPLICABILITY OF THE INVENTION

The present invention relates to a mold useful for manufacturing a molded product such as a simulated stone product and a method for making a molded product.

### BACKGROUND OF THE INVENTION

Simulated stone products include structural pavers, simulated stone veneers and simulated stone architectural trim products. Simulated stone veneers are used as a lightweight veneer facing on masonry, and on metal framed or wood framed construction for architectural aesthetics. The products can be used for exterior applications such as building walls or interior applications such as fireplaces. Simulated stone architectural trim products include capstones, hearthstones, keystones, trimstones and the like. The simulated stone products are usually lower in cost than the natural stones that they replace. CULTURED STONE® products are simulated stone products manufactured by Cultured Stone Corporation, a division of Owens Corning, Napa, Calif. The CULTURED STONES product line includes hundreds of precast stone veneers and architectural trim products that replicate an extensive variety of textures, sizes, shapes and colors of natural stone. The products are manufactured using molds taken from natural stones. The molds generally include a latex layer having a mold cavity, a structural material that supports the bottom of the latex layer, and a tray that holds the structural material and the latex layer. The entire flexible layer may be inflated to assist removal of the several simulated stone products from the mold. In the past, however, there have been problems typically associated with such molds.

The inflation and dislodging of each stone product from the corresponding mold cavities often causes removal problems. When the product is not entirely dislodged, the workers must manually pull the product from the mold. This manual pulling of the product from the flexible layer puts wear and additional stresses on the flexible layer, thereby shortening the useful life of the flexible layer. This manual pulling of the product from the flexible layer also slows down the cycle time of the manufacturing process.

Another problem relates to the safety and cleanliness concerns associated with the handling of such molds.

It is, accordingly, an object of the present invention to provide a novel and improved mold for a simulated stone mold configuration.

The invention will be more readily understood from the following description of a preferred embodiment thereof given, by way of example, with reference to the accompanying drawings.

### SUMMARY OF THE INVENTION

A mold for manufacturing a simulated stone product has a flexible layer having a mold cavity section in the shape of the simulated stone product to be formed. The flexible layer also has a support section surrounding the mold cavity section. The support section is substantially prevented from being flexed or stretched during the unmolding process.

In one aspect, the support section of the flexible layer is more rigid than the mold cavity section. In certain embodiments, the mold cavity section has a first thickness and the support section has a second thickness that is greater than the first thickness. In other embodiments, the support section of the flexible layer includes a reinforcing member. The reinforcing member can be embedded within or provided adjacent the support section. Further, the support section can comprise a first coating of flexible material applied to the first coating, a reinforcing member, and a second coating of flexible material at least partially covering the reinforcing member.

In another aspect, the present invention relates to a mold for manufacturing a simulated stone product which has a flexible layer having a mold cavity section in the shape of the simulated stone product to be formed. The flexible layer also a restrained support section surrounding the mold cavity section. In certain embodiments, the restrained support section includes a restraining member. Further, in certain embodiments, restraining member has a unitary grid shape that at least partially extends over the support section.

In yet another aspect, the present invention relates to a method of manufacturing a simulated stone product comprising:

introducing a castable material into a flexible layer having a mold cavity section and a support section, the castable material substantially filling the mold cavity section;

allowing the castable material to harden to form the simulated stone product;

restraining the support section to prevent the support section from being flexed or stretched; and,

supplying a pressure to the mold cavity section sufficient to cause the mold cavity section to be flexed or stretched, thereby causing the simulated stone product to be at least partially dislodged from the mold cavity section.

Various advantages of this invention will become apparent to those skilled in the art from the following detailed description of the preferred embodiments, when read in light of the accompanying drawings.

### BRIEF DESCRIPTION OF THE DRAWINGS

FIG. 1A is a partial cross-sectional view of one embodiment of a master mold and a production mold.

FIG. 1B is a partial cross-sectional view of another embodiment of a master mold and a production mold.

FIG. 1C is a partial cross-sectional view of yet another embodiment of a master mold and a production mold.

FIG. 2 is a perspective view of still another embodiment of a production mold after a castable material has been introduced into mold cavities formed in a flexible layer of the production mold.

FIG. 3 is a cross-sectional view of the embodiment shown in FIG. 2 showing the castable material being at least partially dislodged from the production mold.

FIG. 4 is a perspective view of still another embodiment of a production mold after a castable material has been introduced into mold cavities formed in a flexible layer of the production mold.

FIG. 5 is a cross-sectional view of the embodiment shown in FIG. 4 showing the castable material being at least partially dislodged from the production mold.

FIG. 6 is a perspective view of still another embodiment of a production mold after a castable material has been introduced into mold cavities formed in a flexible layer of the production mold.

FIG. 7 is a cross-sectional view of the embodiment shown in FIG. 6 showing the castable material being at least partially dislodged from the production mold.

FIG. 8 is a perspective view of still another embodiment of a production mold after a castable material has been introduced into mold cavities formed in a flexible layer of the production mold.

### DETAILED DESCRIPTION OF THE PREFERRED EMBODIMENTS

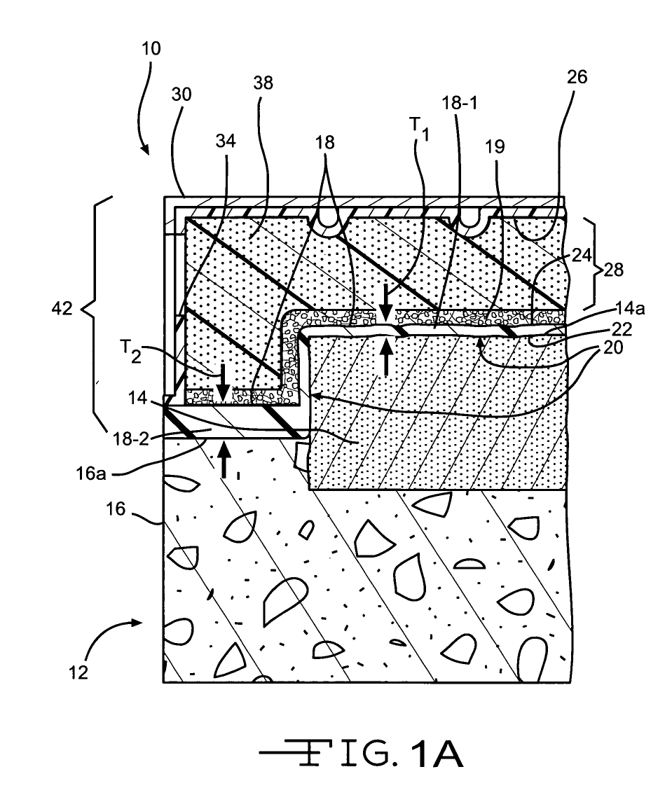

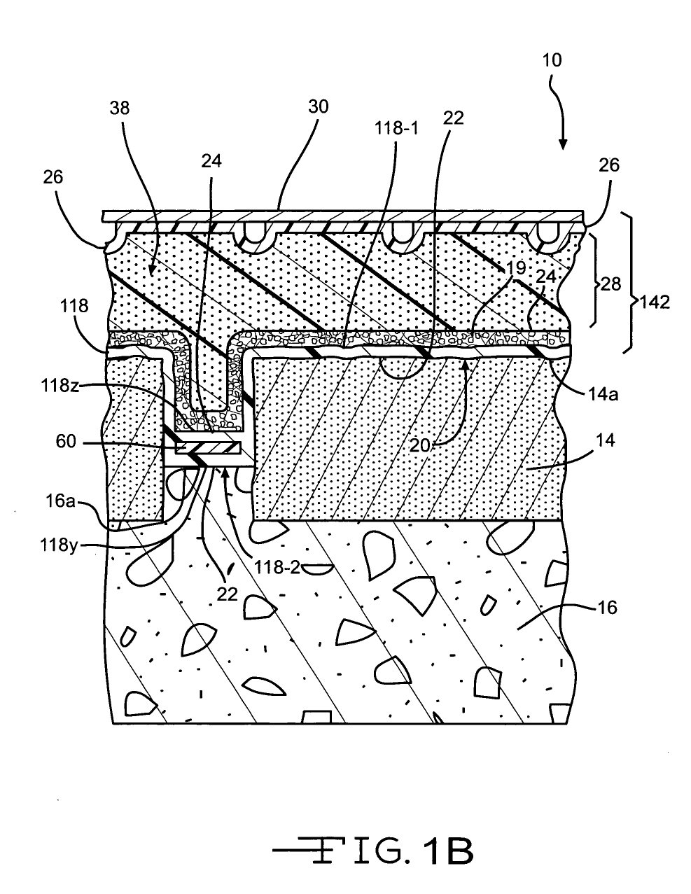

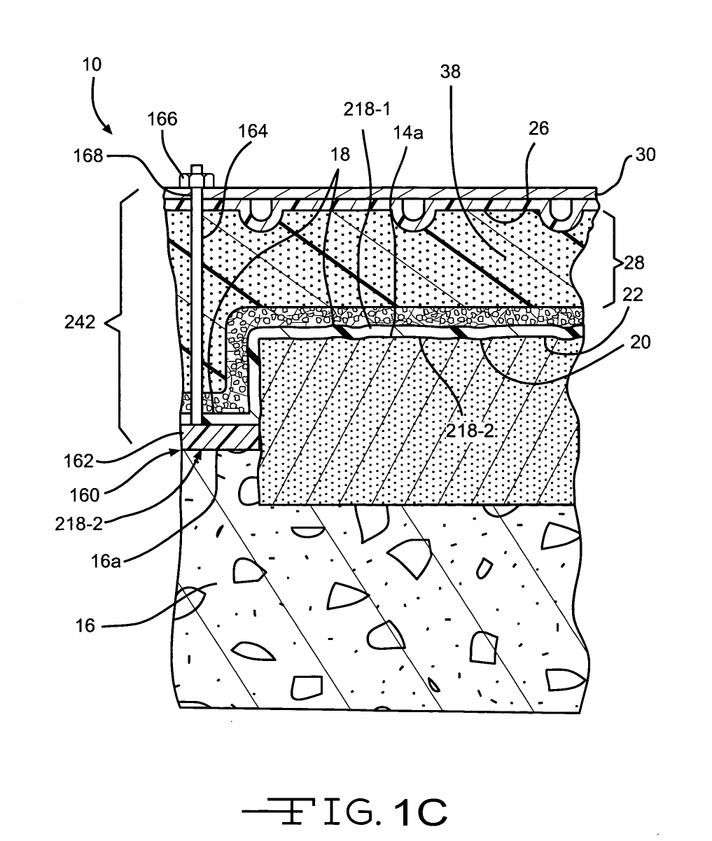

Referring to the drawings, FIG. 1A shows an apparatus 10 useful for manufacturing simulated stone veneers. The apparatus 10 includes a master mold 12. The master mold 12 is produced by setting natural stones 14 in a base 16 so that the stones 14 protrude from a top surface 16a of the base 16. This can be accomplished in any suitable manner. Generally, the master mold 12 is made by pouring a curable urethane or similar curable base 16 around the natural stones 14, and allowing the urethane to cure to set the stones 14 in the base 16.

For the sake of simplification, in the illustrated method the natural stones 14 are shown herein as generally flat pieces that are large and generally square-shaped. However, any desired type of natural stones can be simulated by the method and apparatus of the present invention. For example, the simulated stone products can have various textures and shapes, including rounded river rocks, sandstone, limestone, bricks and the like. The simulated stone products can be in the form of flat pieces, corner pieces, hearth pieces and architectural trim products. Suitable simulated stone include the following types of materials that are made by the assignee herein, Owens Corning, Inc: Cultured Stone® Textures: Blended Textures, Cobblefield®, Coral Stone, Country Ledgestone, Dressed Fieldstone, Drystack Ledgestone, European Castle, Fieldstone, Limestone, Old Country Fieldstone, Pro-Fit Ledgestone®, River Rock, Southern Ledgestone, Split Face, Stream Stones and Weather Edge Ledgestone. Cultured Brick %: Used Brick. Architectural Trim: Capstones, Hearthstones, Keystones and Trim Stones, Quoins, Tuscan Lintels, Watertables and Sills. These products are illustrated on the web site www.culturedstone.com.

The apparatus 10 also includes a generally flexible layer 18 covering the top of the master mold 12. The flexible layer 18 is applied such that the flexible layer 18 conforms to the shape of the natural stones 14, closely following their contours.

The flexible layer 18 covers a top surface 14a of the natural stones 14 and the top surface 16a of the base 16. The flexible layer 18 conforms to the shape of the protruding natural stones 14 to form mold cavities 20 in a first, or outer, surface 22 of the flexible layer 18. The mold cavities 20 are in the shape of the protruding sections of the natural stones 14. The flexible layer 18 also includes a second, or inner, surface 24 opposite the first surface 22.

The flexible layer 18 can be made from any suitable flexible material and can be applied by any suitable method. The flexible material 18 is able to conform its shape around the natural stones 14 and to retain that shape when the flexible layer 18 is removed from the master mold 12 and is in use. In one embodiment, the flexible layer 18 is a curable rubber material such as latex or silicone rubber.

The flexible layer 18 can have more than one suitable thickness. In one embodiment, illustrated in FIG. 1A, flexible layer 18 has mold cavity sections 18-1 which are defined by the mold cavities 20. The mold cavity sections 18-1 are generally highly flexible. The flexible layer 18 also has support sections 18-2 which are defined by the areas surrounding the mold cavity sections 18-1 and the mold cavities 20. In the embodiment shown in FIG. 1, the support sections 18-2 generally have a flexural modulus that is stiffer or more rigid than the flexural modulus of the mold cavity sections 18-1.

In certain embodiments, the mold cavity sections 18-1 can have a relatively thin first thickness T1. In certain embodiments, T1 can be between about ⅛ inch and about ⅜ inches. The support sections 18-2 define a surrounding supporting area around the mold cavity 20. The support sections 18-2 can have a second thickness T2 that is greater than the first thickness T1.

In one embodiment, the support sections 18-2 are formed by supplying additional uncured rubber material as the flexible layer 18 is being formed on the top surface 16a of the base 16. The increased thickness of the T2 section of the flexible layer 18 adds a relative stiffness to the “non-cavity areas”, or T2 sections of the flexible layer 18.

In certain embodiments, a backing layer 19 substantially covers the second surface 24 of the flexible layer 18. The backing layer 19 is applied such that the backing layer 19 also conforms to the shape of the natural stones 14, closely following their contours. In certain embodiments, the backing layer 19 comprises a porous material such as, for example, a breathable mesh material or a urethane/fiberglass applied non-woven mat material.

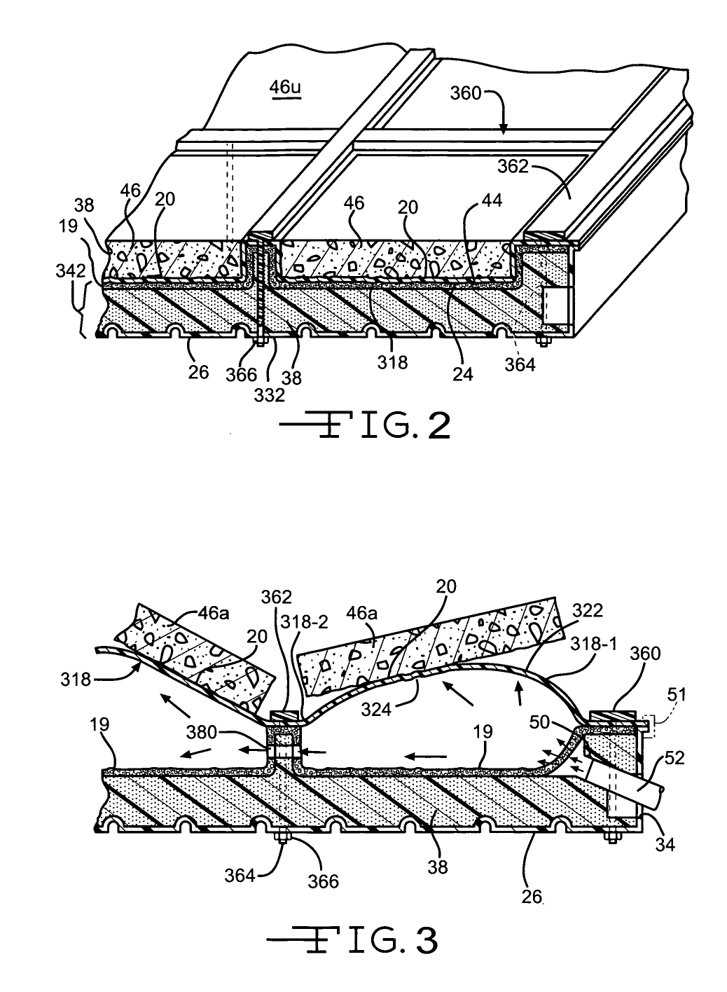

A tray 26 is positioned over the flexible layer 18, or if the backing layer 19 is present, over the backing layer 19. Edges of the tray 26 sit flat on the backing layer 19 on the top surface 16a of the base 16. A space 28 remains between the tray 26 and the flexible layer 18, or the backing layer 19 when present. The mold forming apparatus 10 may also include a rigid fixture 30. The rigid fixture 30 is structured to be positioned over the tray 26 after the tray 26 has been positioned over the master mold 12. The rigid fixture 30 can be made from any suitable material, including, for example, a metal such as steel. The rigid fixture 30, the flexible layer 18 and the backing layer 19 can be secured against the tray 26 with a suitable clamping mechanism, as schematically shown in FIG. 3.

In the illustrated embodiments, a structural material, such as foam 38, fills the space 28 between the tray 26 and the backing layer 19. The structural material 38, when hardened, provides support to the flexible layer 18 during the remaining steps of the mold manufacturing method, as described below. The structural material 38 can be introduced by any suitable means. In the illustrated embodiment in FIG. 3, the structural material 38 is introduced by inserting an injection nozzle 52 through a slot 34 in the tray 26, and injecting the curable structural material 38 into the space 28.

The cured structural material 38 is a load supporting material capable of providing structural strength. Any suitable type of structural material can be used in the manufacturing method. Some examples include foams such as polyurethane, polystyrene and polyphenylene oxide; many other types of structural materials are well known.

After the structural material 38 has cured, the master mold 12 is separated from the flexible layer 18. The removal of the master mold 12 thus leaves a production mold 42. The production mold 42 includes the flexible layer 18, the backing layer 19, the structural material 38 filling the space 28, and the tray 26. The flexible layer 18 retains its shape after removal from the master mold 12; in particular, the shapes of the mold cavities 20 are retained in the flexible layer 18.

Another embodiment is shown in FIG. 1B. For ease of illustration, the features and elements that are common to the embodiments of the present invention will be both labeled and numbered the same herein. Thus, in FIG. 11B, the master mold 12 includes the natural stones 14 and the base 16. A production mold 142 includes the tray 26, the structural material 38 filling the space 28, the backing layer 19 and a flexible layer 118. The flexible layer 118 has mold cavity sections 118-1 which are defined by the mold cavities 20. The mold cavity sections 118-1 are generally highly flexible. The flexible layer 118 also has support sections 118-2 which are defined by the areas surrounding the mold cavity sections 118-1 of the mold cavities 20.

In the embodiment shown in FIG. 1B, the production mold 142 also includes one or more reinforcing members 60 which are embedded in the support sections 118-2. It is to be understood, while not shown, in other embodiments, the production mold 142 also includes one or more reinforcing members 60 which are applied to the support sections 118-2 on the top 16a of the base 16. The reinforcing member 60 can be any suitable material such as, for example, fiberglass, metal or polymeric materials.

The reinforcing members 60 cause the support sections 118-2 to generally have a flexural modulus that is less flexible (i.e., more rigid) than the flexural modulus of the mold cavity sections 118-1. In the embodiment shown in FIG. 1B, the support sections 118-2 can be formed by including at least one or more suitable reinforcing members 60 within the flexible layer 118. In such embodiments, the flexible layer 118 can be formed by applying a first coating 118y of the flexible layer material, then placing the reinforcing member 60 at a desired location, and applying one or more additional layers 118z on top of the reinforcing member 60.

Referring now to FIG. 1C, another embodiment is shown. Again, for ease of illustration, the features and elements that are common to the embodiments of the present invention will be both labeled and numbered the same herein. Thus, in FIG. 1C, the master mold 12 includes the natural stones 14 and the base 16. A production mold 242 includes the tray 26, the structural material 38 filling the space 28, the backing layer 19 and a flexible layer 218. The flexible layer 218 has mold cavity sections 218-1 which are defined by the mold cavities 20. The mold cavity sections 218-1 are generally highly flexible. The flexible layer 218 also has support sections 218-2 which are defined by the areas surrounding the mold cavity sections 218-1 and the mold cavities 20.

In the embodiment shown in FIG. 1C, the production mold 242 also includes one or more restraining members 160 which are applied to the top surface 16a of the base material 16. The restraining members 160 can be made of any suitable material that has a flexural modulus that is stiffer or more rigid than the mold cavity sections 218-1 of the flexible layer 218. In certain embodiments, the restraining member 160 can be any suitable material such as, for example, fiberglass, metal or polymeric materials.

The restraining member 160 includes a restraining section 162 that extends along the top 16a of the base 16 in a generally planar direction. The restraining member 160 can also include at least one anchoring member 164 that extends from the restraining section 162 in a direction away from the planar surface of the top 16a of the base 16. The anchoring member 164 can be positioned such that the flexible layer 18 is held, or restrained, from being flexed or distorted when the production mold 42 is in use, as will be described in detail below.

In the embodiment shown in FIG. 1C, the anchoring member 164 extends in a generally perpendicular manner from the plane of the restraining section 162. The anchoring member 164 ties the support sections 218-2 to the tray 26 and, in certain embodiments, to the rigid fixture 30. When the tray 26 is positioned over the production mold 42, the anchoring members 164 extend from the production mold 242 and can be secured with suitable securing members 166.

One or more individual restraining members 160 can be placed at desired locations on the top surface 16a of the base 16. The desired location can depend, in part, on the shape of the mold cavities 20 and where the flexible layer 218 is needed to be restrained during use.

In certain embodiments, during one method for manufacturing of the production mold 242, the restraining members 160 are placed at the desired locations on the top surface 16a of the base 16 between the stones 14. The flexible layer 18 and then the backing layer 19 are applied to the restraining members 160 on the top 16a of the base 16 and are also applied to the protruding portions of the stones 14. The tray 26 and the rigid fixture 30 are secured over the backing layer 19. The tray 26 and the rigid fixture 30 can include openings 168 that can be aligned with the anchoring sections 164. When the tray 26 is positioned over the production mold 242, the extending anchoring sections 164 extend from the production mold 242 through the tray 26 and can be secured with the securing mechanism 166. Thereafter, the structural material 38 is introduced into the space 28 between the backing layer 19 and the tray 26. The structural material 38 secures the restraining sections 162 against the flexible layer 218.

In certain embodiments, during another method for manufacturing of the production mold 242, the restraining members 160 can be positioned on the flexible layer 218 after the formation of the production mold 242. In such embodiments, the production mold 242 can be formed by applying the flexible layer 218 on the top 16a of the base 16 and the top 14a of the stones 14. Thereafter, the backing layer 19 and the structural material 38 can be supplied to the space 28. The production mold 42 is removed from the master mold 12. The individual restraining members 160 are applied to the mold cavity sections 218-1, and the anchoring members 164 are inserted through the support sections 218-2.

The restraining members 160 are secured to the mold 42 by positioning the anchoring sections 164 through the flexible layer 218, the backing material 19, the structural material 38, and through openings in the tray 26. The anchoring members 164 can puncture the flexible layer 218.

In yet other embodiment, as shown in FIG. 2, a production mold 342 can include a grid-shaped restraining member 360. Again, for ease of illustration, the features and elements that are common to the embodiments of the present invention will be both labeled and numbered the same herein. Thus, in FIG. 2, the master mold 12 includes the natural stones 14 and the base 16. A production mold 342 includes the tray 26, the structural material 38 filling the space 28, the backing layer 19 and a flexible layer 318. The flexible layer 318 has mold cavity sections 318-1 which are defined by the mold cavities 20. The mold cavity sections 318-1 are generally highly flexible. The flexible layer 318 has also support sections 318-2 which are defined by the areas surrounding the mold cavity sections 318-1 and the mold cavities 20.

In certain embodiments, the grid-shaped restraining member 360 includes one or more grid-shaped restraining sections 362 interconnected to form a unitary grid shape. The length and/or width of the grid-shaped restraining sections 362 can vary because a single mold 10 can include numerous cavities of different sizes and shapes to form products of different sizes and shapes. The grid-shaped restraining member 360 can be any suitable material such as, for example, fiberglass, metal or thermoplastic materials.

Also, in certain embodiments, the grid restraining member 360 has one or more anchoring members 364 extending from the grid-shaped restraining section 362 at spaced apart intervals. In certain embodiments, the anchoring member 364 can be secured by a securing member 366, such as, for example, a nut. The anchoring member 364 can be positioned such that the flexible layer 318 is restrained from being flexed or distorted when the production mold 342 is in use, as will be described in detail below.

In certain embodiments, during one method for manufacturing of the production mold 342, the grid-shaped restraining member 360 is placed on the top surface 16a of the base 16 between the stones 14. The flexible layer 318 and then the backing layer 19 are applied to the top 16a of the base 16 and to the stones 14. The tray 26 and the rigid fixture 30 are secured over the backing layer 19. The tray 26 and the rigid fixture 30 can include openings 332 that can be aligned with the anchoring sections 364. When the tray 26 is positioned over the production mold 342, the extending anchoring sections 364 extend from the production mold 342 through the tray 26 and can be secured with a suitable securing mechanism 366. Thereafter, the structural material 38 is introduced into the space 28 between the backing layer 19 and the tray 26. The structural material 38 secures the grid-shaped restraining sections 362 against the support sections 318-2 of the flexible layer 318.

In certain embodiments, during another method for manufacturing of the production mold 342, at least one restraining member 360 can be positioned on the flexible layer 318 after the formation of the production mold 342. In such embodiment, the production mold 342 can be formed by applying the flexible layer 318 on the top 16a of the base 16 and the top 14a of the stones 14. Thereafter, the backing layer 19 and the structural material layer 38 can be applied. The production mold 342 is removed from the master mold 12. The grid-shaped restraining members 360 are applied to the mold cavity sections 318-1, and the anchoring members 364 are inserted through the support sections 318-2.

The grid-shaped restraining members 360 are secured to the mold 342 by positioning the anchoring sections 364 through the flexible layer 318, the backing material 19, the structural material 38, and through openings in the tray 26. The anchoring members 364 can puncture the flexible layer 318.

In the embodiment shown, the anchoring members 364 extend in a generally perpendicular manner from the plane of the grid-shaped restraining section 362. When the tray 26 is positioned over the production mold 342, the anchoring members 364 extend from the production mold 342 and can be secured with suitable securing members 366.

Referring now to FIGS. 2 and 3, one suitable production mold 342 having a grid-shaped restraining member 360 is shown in use where the tray 26, the structural material 38 and the backing layer 19 provide support to the flexible layer 318. In the illustrated embodiment, the tray 26 and the structural material 38 are inverted and positioned on a suitable surface (not shown), such as a conveyor belt in a manufacturing plant.

After the production mold 342 has been set in position, a castable material 46 is introduced into the mold cavities 20 formed in the flexible layer 318. The castable material 46 can be introduced by any suitable means, such as by pouring it into the mold cavities 20. In certain embodiments, the production mold 342 may be vibrated after introducing the castable material 46 into the mold cavity to insure that the castable material 46 flows into all the contours of the mold cavity 20.

After hardening, the castable material 46 in each of the mold cavities 20 becomes a molded product 46a having a shape substantially corresponding to the shape of the mold cavity 20, which in turn has a shape substantially corresponding to the shape of a master stone 14 (each stone, mold shape and product being a corresponding male/female/male impression in the illustrated examples). In the illustrated embodiment, the molded product 46a comprises simulated stone veneers in the form of flat pieces. It is to be understood that any suitable castable material 46 can be used for producing the molded products such as simulated stone veneers. In one embodiment, the castable material 46 is a lightweight concrete material comprising Portland cement and lightweight aggregates. However, other castable materials are also useful, such as plaster of Paris or a ceramic material.

After hardening, the molded product 46a is then removed from the mold cavities 20, as illustrated in FIG. 3. A suitable amount of pressurized fluid, such as air, generally shown as arrows in FIG. 3, is introduced into the production mold 342. The fluid contacts an inner surface 324 of the flexible layer 318 causing the mold cavity sections 318-1 to be stretched or distended, thereby lifting the molded product 46a from its mold cavity 20. The support sections 318-2 of the flexible layer 318 are at least partially restrained, or prevented, from being distended.

The molded product 46a is at least partially dislodged from the mold cavity 20 by supplying fluid between the second surface 324 of the flexible layer 318 and the rigid fixture 30. The support sections 318-2 of the flexible material 318 are restrained from being stretched or distorted by the fluid being introduced between the second surface 324 of the flexible layer 318 and the rigid fixture 30. In embodiments where the porous backing layer 19 is present, the fluid passes through the porous backing layer 19 and contacts the second surface 324 of the flexible layer 318.

It should be noted that FIG. 3 illustrates a cross-sectional view of one suitable configuration for a production mold in order to introduce the fluid into the production mold. In the embodiment shown in FIG. 3, one or more openings 380 extend laterally through the support sections 318-2 (which are generally defined by the areas surrounding the mold cavity sections 318-1 and the mold cavities 20). Thus, the openings 380 allow fluid to flow into each of the mold cavity sections 318-1 and through the entire production mold 342. As such, while not shown in the other embodiments described herein, it is within the contemplated scope of the present invention that such embodiments can also have the unmolding features illustrated in FIG. 3.

Referring again to FIG. 3, a bore 50 can be formed through the structural material 38. Any suitable method can be used to form the bore 50, such as by drilling or cutting through the structural material 38. In certain embodiments, a clamping mechanism 51 holds the flexible layer 318 to the structural material 38 and the tray 26.

During removal of the molded product 46a from any of the production molds described herein, a fluid injection nozzle 52 is inserted into the bore 50. The fluid injection nozzle 52 blows pressurized fluid against the second surface 324 of the flexible layer 318. The edges of the flexible layer 318 are clamped on the tray 26. As shown in FIG. 3, the injection of the fluid causes the mold cavity section 318-1 of the flexible layer 318 to be stretched or distorted while the support section 318-2 remains positioned near or against the top surface 16a of the base 16. The combination of the flexibility of the mold cavity section 318-1 and the restraint of the support section 318-2 allows the molded product 46a to be readily at least partially dislodged from the mold cavities 20 in the flexible layer 318.

It is to be understood that the fluid can be water or air which is supplied at sufficient volumes and/or pressures to at least partially dislodge the molded product. It is also understood that the desired volumes and/or pressures of such fluids will vary depending on the shape, size, configuration and composition of the molded product. In embodiments where the anchoring members puncture the flexible layers, respectively, a sufficient volume and/or pressure against the flexible layers is supplied during unmolding such that any leakage of fluid near the puncture does not substantially affect the dislodging of the molded product.

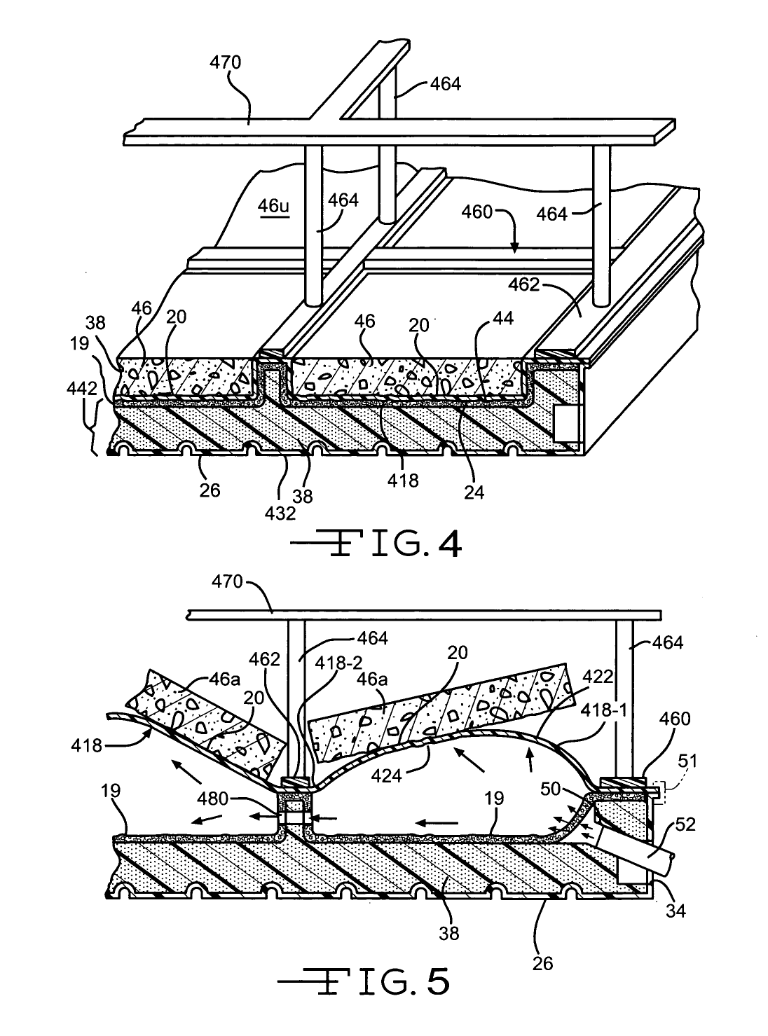

In yet other embodiment, as shown in FIG. 4, an external restraining member 460 can be used. Again, for ease of illustration, the features and elements that are common to the embodiments of the present invention will be both labeled and numbered the same herein. Thus, in FIG. 4, the master mold 12 includes the natural stones 14 and the base 16. A production mold 442 includes the tray 26, the structural material 38 filling the space 28, the backing layer 19 and a flexible layer 418. The flexible layer 418 has mold cavity sections 418-1 which are defined by the mold cavities 20. The mold cavity sections 418-1 are generally highly flexible. The flexible layer 418 has also support sections 418-2 which are defined by the areas surrounding the mold cavity sections 418-1 and the mold cavities 20.

In certain embodiments, the external restraining member 460 includes one or more restraining sections 462 interconnected to form a unitary grid shape. In other embodiments, the restraining sections 462 can be discontinuous. The length and/or width of the restraining sections 462 can vary because a single mold 10 can include numerous cavities of different sizes and shapes to form products of different sizes and shapes. The external restraining member 460 can be any suitable material such as, for example, fiberglass, metal or thermoplastic materials.

Also, in certain embodiments, the external member 460 has one or more connection members 464 extending from the restraining section 462 at spaced apart intervals. In certain embodiments, the connection member 464 can be secured to a positioning device, schematically shown as 470. The positioning device 470 is operatively connected to the external restraining member 460 such that the restraining sections 462 can be positioned in contact with or immediately adjacent the flexible layer 418, thereby restraining the flexible layer 418 from being flexed or distorted when the production mold 442 is in use.

In the embodiment shown in FIGS. 4 and 5, the restraining section 462 has substantially the same configuration as the supporting sections 418-2 of the production mold 442. The connection members 464 extend in a generally perpendicular manner from the plane of the restraining section 462 at spaced apart positions.

It is to be understood that the location of each connection member 464 is determined by the desired force that is to be applied to the production mold 442 during the unmolding process. Thus, the location of the connection members 464 can be determined, at least in part, by the rigidity of the restraining section 462.

Further, it should be understood, that while the embodiments shown in FIGS. 4 and 5 illustrate an external restraining member 460 that is uniquely shaped to a particular production mold 442, in other embodiments, the external restraining member can have a more generic configuration such that such generic external restraining member can be used with numerous and differently configured production mold. In such embodiments, the restraining sections 462 can be non-unitary and, thereby, fit between the mold cavity sections 418-1.

Referring again to FIGS. 4 and 5, one suitable production mold 442 having the external restraining member 460 is shown in use where the tray 26, the structural material 38 and the backing layer 19 provide support to the flexible layer 418. In the illustrated embodiment, the tray 26 and the structural material 38 are inverted and positioned on a suitable surface (not shown), such as a conveyor belt in a manufacturing plant.

After the production mold 442 has been set in position, a castable material 46 is introduced into the mold cavities 20 formed in the flexible layer 418. The castable material 46 can be introduced by any suitable means, such as by pouring it into the mold cavities 20. In certain embodiments, the production mold 442 may be vibrated after introducing the castable material 46 into the mold cavity to insure that the castable material 46 flows into all the contours of the mold cavity 20.

After hardening, the castable material 46 in each of the mold cavities 20 becomes a molded product 46a. In the illustrated embodiment, the molded product 46a comprises simulated stone veneer in the form of substantially flat pieces. It is to be understood that any suitable castable material 46 can be used for producing the molded products such as simulated stone veneers.

After hardening, the molded product 46a is then removed from the mold cavities 20, as illustrated in FIG. 5. The external restraining member 460 is brought into contact with the production mold 442 by the positioning device 470. The restraining sections 462 are at least partially restrain, or prevent portions of the support sections 418-2 of the flexible layer 418 from being distended.

A suitable amount of pressurized fluid, such as air, generally shown as arrows in FIG. 5, is introduced into the production mold 442. The fluid contacts an inner surface 424 of the flexible layer 418 causing the mold cavity sections 418-1 to be stretched or distended, thereby lifting the molded product 46a from its mold cavity 20.

The molded product 46a is at least partially dislodged from the mold cavity 20 by supplying fluid between the second surface 424 of the flexible layer 18 and the rigid fixture 30. The support sections 418-2 of the flexible material 18 are restrained from being stretched or distorted by the fluid being introduced between the second surface 424 of the flexible layer 418 and the rigid fixture 30. In embodiments where the porous backing layer 19 is present, the fluid passes through the porous backing layer 19 and contacts the second surface 424 of the flexible layer 418.

It should be noted that FIG. 5 illustrates a cross-sectional view of one suitable configuration for a production mold in order to introduce the fluid into the production mold.

In the embodiment shown in FIG. 5, one or more openings 480 extend laterally through the support sections 418-2 (which are generally defined by the areas surrounding the mold cavity sections 418-1 and the mold cavities 20). Thus, the openings 480 allow fluid to flow into each of the mold cavity sections 418-1 and through the entire production mold 442.

As such, while not shown in the other embodiments described herein, it is within the contemplated scope of the present invention that such embodiments can also have the unmolding features illustrated in FIG. 5.

Referring again to FIG. 5, a bore 50 can be formed through the structural material 38. Any suitable method can be used to form the bore 50, such as by drilling or cutting through the structural material 38. In certain embodiments, a clamping mechanism 51 holds the flexible layer 418 to the structural material 38 and the tray 26.

During removal of the molded product 46a from any of the production molds described herein, a fluid injection nozzle 52 is inserted into the bore 50. The fluid injection nozzle 52 blows pressurized fluid against the second surface 424 of the flexible layer 418. The edges of the flexible layer 418 are clamped on the tray 26. As shown in FIG. 5, the injection of the fluid causes the mold cavity section 418-1 of the flexible layer 418 to be stretched or distorted while the support section 418-2 remains positioned near or against the top surface 16a of the base 16. The combination of the flexibility of the mold cavity section 418-1 and the restraint of the support section 418-2 allows the molded product 46a to be readily at least partially dislodged from the mold cavities 20 in the flexible layer 418.

In yet other embodiment, as shown in FIG. 6, an external restraining member 660 can be used. Thus, another aspect of the present invention relates to a mold assembly including a production mold 642 and an external restraining member 660 configured to be brought into contact with the restrainable support section of the mold during an unmolding process. The external restraining member 660 includes a plurality of restraining sections 662 configured to contact individual areas of the restrainable support section of the mold.

Again, for ease of illustration, the features and elements that are common to the embodiments of the present invention will be both labeled and numbered the same herein. Thus, in FIG. 6, the master mold 12 includes the natural stones 14 and the base 16. A production mold 642 includes the tray 26, the structural material 38 filling the space 28, the backing layer 19 and a flexible layer 618. The flexible layer 618 has mold cavity sections 618-1 which are defined by the mold cavities 20. The mold cavity sections 618-1 are generally highly flexible. The flexible layer 618 has also support sections 618-2 which are defined by the areas surrounding the mold cavity sections 618-1 and the mold cavities 20.

In certain embodiments, the external restraining member 660 includes one or more restraining sections 662. The length and/or width of the restraining sections 662 can vary because a single mold can include numerous cavities of different sizes and shapes to form products of different sizes and shapes. The external restraining member 660 can be any suitable material such as, for example, fiberglass, metal or thermoplastic materials.

The restraining sections 662 are operatively connected to the external restraining member 660 such that the restraining sections 662 can be positioned in contact with or immediately adjacent the flexible layer 618, thereby restraining the flexible layer 618 from being flexed or distorted when the production mold 642 is in use.

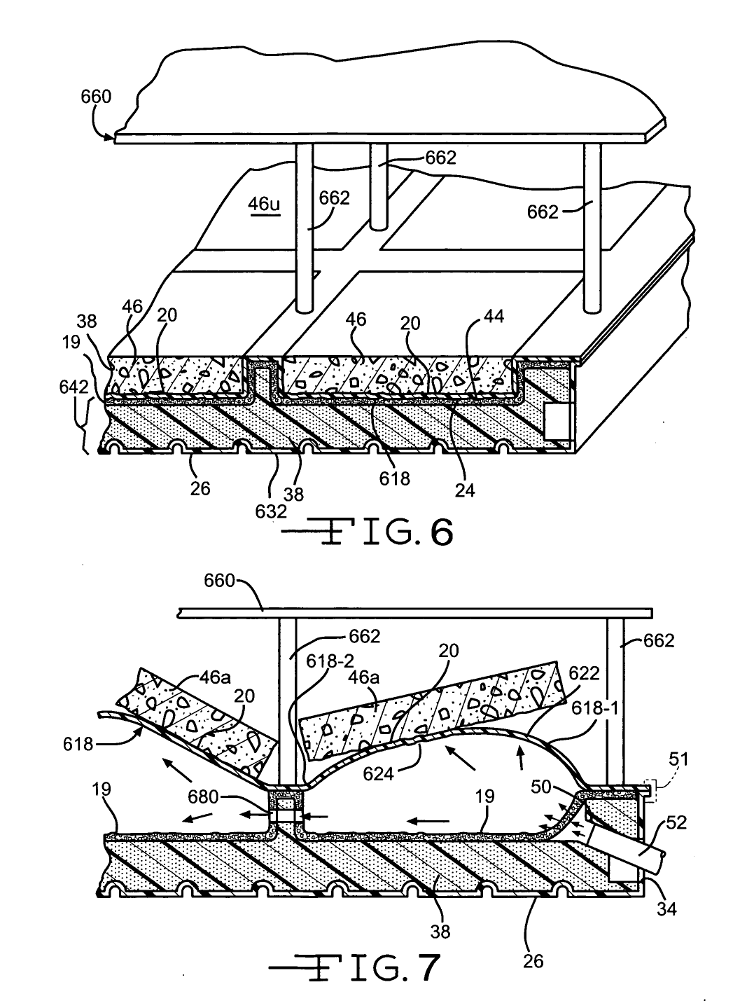

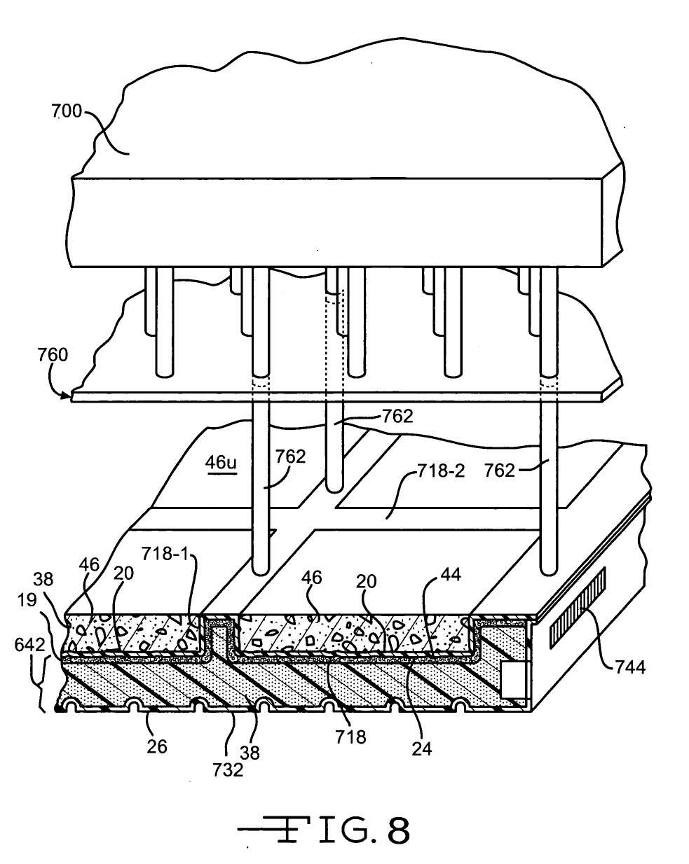

In the embodiment shown in FIGS. 6 and 7, the restraining sections 662 are positioned at desired locations against the supporting sections 618-2 of the production mold 642. The restraining sections 662 extend in a generally perpendicular manner from a plane defined by the supporting sections 618-2.

It is to be understood that the location of each restraining sections 662 is determined by the desired force that is to be applied to the production mold 642 during the unmolding process. Thus, the location of the restraining sections 662 can be determined, at least in part, by the rigidity of the support sections 618-2.

Further, it should be understood that, while the embodiments shown in FIGS. 6 and 7 illustrate an external restraining member 760 that is uniquely shaped to a particular production mold 442, in other embodiments, the external restraining member can have a more generic configuration so that such generic external restraining member can be used with numerous and differently configured production molds.

Referring again to FIGS. 6 and 7, after the production mold 642 has been set in position, a castable material 46 is introduced into the mold cavities 20 formed in the flexible layer 618. The castable material 46 can be introduced by any suitable means, such as by pouring it into the mold cavities 20. In certain embodiments, the production mold 642 may be vibrated after introducing the castable material 46 into the mold cavity to insure that the castable material 46 flows into all the contours of the mold cavity 20.

After hardening, the molded product 46a is then removed from the mold cavities 20, as illustrated in FIG. 7. The external restraining member 660 is brought into contact with the production mold 642. The restraining sections 662 at least partially restrain, or prevent, portions of the support sections 618-2 of the flexible layer 618 from being distended.

A suitable amount of pressurized fluid, such as air, generally shown as arrows in FIG. 7, is introduced into the production mold 642. The fluid contacts an inner surface 624 of the flexible layer 618 causing the mold cavity sections 618-1 to be stretched or distended, thereby lifting the molded product 46a from its mold cavity 20.

The molded product 46a is at least partially dislodged from the mold cavity 20 by supplying fluid between the second surface 624 of the flexible layer 618 and the rigid fixture 30. The support sections 618-2 of the flexible material 618 are restrained from being stretched or distorted by the fluid being introduced between the second surface 624 of the flexible layer 618 and the rigid fixture 30. In embodiments where the porous backing layer 19 is present, the fluid passes through the porous backing layer 19 and contacts the second surface 624 of the flexible layer 618.

It should be noted that FIG. 7 illustrates a cross-sectional view of one suitable configuration for a production mold in order to introduce the fluid into the production mold. In the embodiment shown in FIG. 7, one or more openings 680 extend laterally through the support sections 618-2 (which are generally defined by the areas surrounding the mold cavity sections 618-1 and the mold cavities 20). Thus, the openings 680 allow fluid to flow into each of the mold cavity sections 618-1 and through the entire production mold 642.

As such, while not shown in the other embodiments described herein, it is within the contemplated scope of the present invention that such embodiments can also have the unmolding features illustrated in FIG. 7.

Referring again to FIG. 7, a bore 50 can be formed through the structural material 38. Any suitable method can be used to form the bore 50, such as by drilling or cutting through the structural material 38. In certain embodiments, a clamping mechanism 51 holds the flexible layer 618 to the structural material 38 and the tray 26.

In yet other embodiment, as shown in FIG. 8, a tracking system 700 is operatively connected to an external restraining system 760.

Again, for ease of illustration, the features and elements that are common to the embodiments of the present invention will be both labeled and numbered the same herein. Thus, in FIG. 8, the master mold 12 includes the natural stones 14 and the base 16. A production mold 742 includes the tray 26, the structural material 38 filling the space 28, the backing layer 19 and a flexible layer 718. The flexible layer 718 has mold cavity sections 718-1 which are defined by the mold cavities 20. The mold cavity sections 718-1 are generally highly flexible. The flexible layer 718 has also support sections 718-2 which are defined by the areas surrounding the mold cavity sections 718-1 and the mold cavities 20.

The external restraining system 760 includes a plurality of restraining sections 762 configured to contact individual areas of the restrainable support sections 718-2 of the production mold 742. Each restraining section 672 is capable of being individually extended and retracted. In certain embodiments, the external restraining member 760 provides a grid or pattern or restraining sections 762 so that any desired pattern of external restraining section 762 can be used. The external restraining member 760 is thus useful with numerous and differently configured production molds.

It is to be understood that the location of each restraining sections 762 is determined by the desired force that is to be applied to the production mold 742 during the unmolding process. Thus, the location of the restraining sections 762 are determined by the shape of each particular mold that is being unmolded.

The length and/or width of the restraining sections 762 can vary because a single mold can include numerous cavities of different sizes and shapes to form products of different sizes and shapes. The external restraining system 760 can be any suitable material such as, for example, fiberglass, metal or thermoplastic materials.

The restraining sections 762 are operatively connected to the external restraining system 760 such that individual restraining sections 762 are capable of being moved or positioned in contact with or immediately adjacent the flexible layer 718, thereby restraining the flexible layer 718 from being flexed or distorted when the production mold 742 is being unmolded.

The tracking system 700 identifies each individual production mold 718 as the mold is brought into position beneath the external restraining system 760. The tracking system identifies the particular mold and positions specific restraining sections 762 in a desired position for the securing the restrainable support sections 718-2 and allowing the mold cavity sections 718-1 to be flexed or stretched during the unmolding of each production mold 742.

Each production mold 742 includes a mobile tracking device 744 which is read by the tracking system 700. The mobile tracking device 744 can be any suitable tracking device such as a bar code or a radio frequency identification device (RFID). In certain embodiments, the RFID device can be a passive RFID tag which has no internal power supply and which contain not only an ID number but also can contains nonvolatile EEPROM (Electrically Erasable Programmable Read-Only Memory) for storing data; a semi-passive RFID tag which is similar to passive tags except for the addition of a small battery which allows the tag to be constantly powered; or, an active RFID tag which has an internal power source to generate the outgoing signal which allows the tag to have longer ranges and larger memories than passive tags, as well as the ability to store additional information. In such embodiments, it is understood that the tracking system 700 generally includes any suitable components that are normally used in such systems, including, for example, tags, tag readers, edge servers, middleware, and application software.

The tracking system 700 reads data on or in the mobile tracking device 744. The data may include identification or location information, specifics about the production mold, such as shape, amount of pressure needed to unmold the stone, and the like.

During removal of the molded product 46a the mold cavity section 718-1 of the flexible layer 718 is stretched or distorted while the support section 718-2 remains positioned near or against the top surface of the base. The combination of the flexibility of the mold cavity section 718-1 and the restraint of the support section 718-2 allows the molded product 46a to be readily at least partially dislodged from the mold cavities 20 in the flexible layer 718.

During removal of the molded product 46a from any of the production molds described herein, a fluid injection nozzle 52 is inserted into the bore 50. The fluid injection nozzle 52 blows pressurized fluid against the second surface 624 of the flexible layer 618. The edges of the flexible layer 618 are clamped on the tray 26. As shown in FIG. 5, the injection of the fluid causes the mold cavity section 618-1 of the flexible layer 618 to be stretched or distorted while the support section 618-2 remains positioned near or against the top surface of the base. The combination of the flexibility of the mold cavity section 618-1 and the restraint of the support section 618-2 allows the molded product 46a to be readily at least partially dislodged from the mold cavities 20 in the flexible layer 618.

It is to be understood that the methods described herein for dislodging the molded product works for all the embodiments generally described and/or shown herein, for example:

In FIG. 1A, since the support sections 18-2 are relatively thick and generally have a flexural modulus that is stiffer, or more rigid, than the flexural modulus of the mold cavity sections 18-1, the mold cavity sections 18-1 are allowed to stretch and flex to a greater extent than the support sections 18-2.

In FIG. 1B, the reinforcing members 60 strengthen and/or stiffen the support sections 118-2, while allowing the mold cavity sections 118-1 to stretch and flex.

In FIG. 1C, the restraining member 160 holds, or at least partially restrains, the support sections 218-2 from being flexed or distorted while allowing the mold cavity sections 218-1 to stretch and flex.

In FIGS. 2 and 3, the grid-shaped restraining member 360 and the anchoring members 364 extending from the grid-shaped restraining sections 362 hold, or at least partially restrain, the support sections 318-2 from being flexed or distorted while allowing the mold cavity sections 318-1 to stretch and flex.

In FIGS. 4 and 5, the external restraining member 460 and the restraining sections 462 prevent, or at least partially restrain, the support sections 418-2 from being flexed or distorted while allowing the mold cavity sections 418-1 to stretch and flex.

In FIGS. 6 and 7, the external restraining member 660 and the restraining sections 662 prevent, or at least partially restrain, the support sections 618-2 from being flexed or distorted while allowing the mold cavity sections 618-1 to stretch and flex.

In FIG. 8, the tracking system 700 identifies the particular mold and activates the desired pattern of restraining sections 762 to be brought into contact with the desired support sections 718-2. The restraining sections 762 prevent, or at least partially restrain, the support sections 718-2 from being flexed or distorted while allowing the mold cavity sections 718-1 to stretch and flex.

The individual dislodging of each mold product from the corresponding mold cavity within the flexible layer reduces the removal problems that have been typically associated with such molds. The mold and the method of using such molds, as described herein, improve the safety of the process by only allowing certain sections of the flexible layer to be distorted. Also, the cycle time for manufacturing such stone products is reduced.

Another advantage is that the inflation of only the individual mold cavities and not the areas surrounding the mold cavities greatly increases the useful life of the mold.

Also, in embodiments where the grid-shaped restraining member is used, there is an increase in the process cleanliness.

The present invention is especially useful for the manufacturing of the simulated stone veneer products which are usually relatively thinner and lighter as compared to the natural stones and structural pavers that the simulated products replace.

It is to be understood that, in certain embodiments, the production mold can include any, or all, of the features shown in the Figures herein; that is, the production mold can have one or more of the following features in one production mold:

relatively thicker support sections of the flexible layer;

at least one restraining member embedded in some or all of the support sections of the flexible layer; and/or

at least one restraining member applied to (rather than embedded within) the support sections of the flexible layer.

It is to be further understood that such embodiments may depend, in part, upon the shapes, sizes and configurations of the natural stone and hence the shapes of the mold cavities within the flexible material.

While the invention has been described with reference to a preferred embodiment, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A mold for manufacturing a simulated stone product comprising a flexible layer having a mold cavity section with a shape substantially corresponding to the simulated stone product to be formed, and a support section substantially surrounding the mold cavity section, the support section being configured to substantially resist flexing during unmolding of the simulated stone product.

2. The mold of claim 1, wherein the mold cavity section has a first thickness and the support section has a second, greater thickness.

3. The mold of claim 1, wherein the support section of the flexible layer is more rigid than the mold cavity section of the flexible layer.

4. The mold of claim 3, wherein a reinforcing member is applied to the support section of the flexible layer.

5. The mold of claim 3, wherein the reinforcing member is embedded within the support section of the flexible layer.

6. The mold of claim 4, wherein the mold includes a plurality of separate reinforcing members.

7. The mold of claim 1, wherein the support section comprises a first coating of flexible material, a reinforcing member applied to the first coating of flexible material, and a second coating of flexible material at least partially covering the reinforcing member.

8. The mold of claim 1, further including a structural material substantially conforming to the mold cavity and providing support to the mold cavity, and a porous backing layer interposed between the structural material and the flexible layer.

9. The mold of claim 1, wherein the mold includes a plurality of mold cavities.

10. A mold for manufacturing a simulated stone product comprising a flexible layer having a mold cavity section defining a mold cavity in having a shape substantially corresponding to the simulated stone product to be formed, and a support section substantially surrounding the mold cavity section; wherein the support section includes a reinforcing member.

11. The mold of claim 10, wherein the reinforcing member is embedded within the support section.

12. The mold of claim 10, wherein the support section comprises a first coating of flexible material, a reinforcing member applied to the first coating of flexible material, and a second coating of flexible material at least partially covering the reinforcing member.

13. The mold of claim 10, wherein the mold includes a plurality of reinforcing members.

14. The mold of claim 10, wherein the mold includes a unitary reinforcing member.

15. The mold of claim 10, further including a structural material substantially conforming to the mold cavity and providing support to the mold cavity, and a porous backing layer interposed between the structural material and the flexible layer.

16. The mold of claim 10, wherein the mold includes a plurality of mold cavities.

17. A mold for manufacturing a simulated stone product comprising a flexible layer having a mold cavity section having a shape substantially corresponding to the simulated stone product to be formed, and a restrained support section substantially surrounding the mold cavity section.

18. The mold of claim 17, wherein the restrained support section includes a restraining member.

19. The mold of claim 18, wherein the restraining member forms a unitary grid shape.

20. The mold of claim 19, wherein the restraining member includes one or more anchoring members extending from the restraining member at spaced apart intervals.

21. The mold of claim 20, including a plurality of separate restraining members.

22. The mold of claim 18, wherein the restraining member is embedded within the restrained support section.

23. The mold of claim 17, wherein the restrained support section comprises a first coating of flexible material, a restraining member applied to the first coating of flexible material, and a second coating of flexible material at least partially covering the restraining member.

24. The mold of claim 22, wherein the mold includes a plurality of restraining members.

25. The mold of claim 17, further including a structural material substantially conforming to the mold cavity and providing support to the mold cavity, and a porous backing layer interposed between the structural material and the flexible layer.

26. The mold of claim 17, wherein the mold includes a plurality of mold cavities.

27. A mold assembly for manufacturing a simulated stone product comprising:
a mold having a flexible layer having a mold cavity section having a shape substantially corresponding to the simulated stone product to be formed, and a restrainable support section; and,
an external restraining member configured to be brought into contact with the restrainable support section of the mold during an unmolding process.

28. The mold assembly of claim 27, wherein the external restraining member includes a plurality of restraining sections configured to contact individual areas of the restrainable support section of the mold.

29. The mold assembly of claim 27, wherein the external restraining member forms a unitary grid shape.

30. The mold assembly of claim 27, wherein the external restraining material comprises a plurality of separate restraining sections configured to contact individual portions of the support section of the mold.

31. The mold assembly of claim 27, wherein the mold is adapted to be tracked by a tracking system.

32. The mold assembly of claim 31, wherein the tracking device comprises a bar code or a radio frequency identification device.

33. A molding assembly for manufacturing a simulated stone product comprising:
a mold having a flexible layer having a mold cavity section with a shape substantially corresponding to a simulated stone product to be formed, a restrainable support section, and a tracking device;
an external restraining member configured to be brought into contact with the restrainable support section of the mold during an unmolding process;
the external restraining system including a plurality of restraining sections, each restraining section adapted to be individually extended and retracted; and,
tracking system adapted to identify the mold, read the tracking device and extend one or more of the restraining sections of the external restraining member.

34. The molding assembly of claim 33, wherein the plurality of restraining sections are configured to contact individual areas of the restrainable support section of the mold.

35. The mold assembly of claim 34, wherein the tracking device comprises a bar code or a radio frequency identification device.

36. A method of manufacturing a simulated stone product comprising:
introducing a castable material into a flexible layer having a mold cavity section and a support section, the castable material substantially filling the mold cavity section;
allowing the castable material to harden to form the simulated stone product;
substantially restraining the support section; and
applying pressure to the mold cavity section layer sufficient to cause the mold cavity section to be flexed, thereby at least partially dislodging the simulated stone product from the mold cavity section.

37. The method of claim 36, wherein pressure is supplied by supplying fluid to a back of the mold cavity section.

38. The method of claim 36, wherein the support section is restrained by embedding a restraining material within the support section.

39. The method of claim 38, wherein the embedded restraining material comprises a grid shaped material.

40. The method of claim 38, wherein the support section is restrained by a restraining material external to the support section.

41. The method of claim 40, wherein the external restraining material comprises a grid shaped material.

42. The method of claim 40, wherein the external restraining material comprises a plurality of separate restraining sections that contact individual portions of the support section of the mold.

43. The method of claim 42, wherein the mold has a tracking device capable of being read by a tracking system, and wherein the external restraining member positions one or more restraining sections in a desired position for the securing the restrainable support sections.

44. The method of claim 43, wherein the tracking system reads data from the tracking device, wherein the data includes one or more of: identification or location information of the mold, identification of mold shape, and amount of pressure needed to unmold the simulated stone product.

45. The method of claim 43, wherein the tracking device comprises a bar code or a radio frequency identification device.

46. The method of claim 40, comprising restraining the support section by positioning the restraining material adjacent or in proximity to the support section after the castable material hardens to form the simulated stone product.

47. The method of claim 39, comprising restraining the support section by positioning the restraining material adjacent or in proximity to the support section before the castable material is introduced into the mold cavity section.

48. The method of claim 37, wherein the fluid comprises air.
